(19) United States
(12) Patent Application Publication
(10) Pub. No.: US 2011/0289426 A1
(43) Pub. Date: Nov. 24, 2011

(54) EVENT BASED INTERACTIVE NETWORK FOR RECOMMENDING, COMPARING AND EVALUATING APPEARANCE STYLES

(75) Inventors: Lois J. Sonstegard, Orono, MN (US); Soorena Salari, Irwindale, CA (US)

(73) Assignee: LJL, INC., Minneapolis, MN (US)

(21) Appl. No.: 13/112,867

(22) Filed: May 20, 2011

Related U.S. Application Data
(60) Provisional application No. 61/395,967, filed on May 20, 2010.

(51) Int. Cl. G06F 3/00

(52) U.S. Cl. 715/745

(57) ABSTRACT

A method is provided of assisting a user with a selection of a personal appearance style over an interactive computer based network. Digital images of personal appearance styles are stored on a host computer in a database. Combinations of physical characteristics and personality characteristics are also stored on the host computer in the database, as are various business and/or social events. Information is received from the user related to physical and/or personality characteristics of the user, and related to an event the user will be attending. The host computer then determines personal appearance styles that are compatible with the user's physical and/or personality characteristics and the event the user will be attending, and transmits and displays those personal appearance styles to the user. A method is further provided to receive and compile feedback through a social networking arrangement over an interactive computer based network on a personal appearance style selected by a user for a past event.

### CROSS-REFERENCE TO RELATED APPLICATION(S)

This application claims the benefit of U.S. Provisional Application No. 61/395,967 filed May 20, 2010 for “Event Based Interactive Network for Recommending, Comparing and Evaluating Appearance Styles” by L. Sonstegard and S. Salari.

### INCORPORATION BY REFERENCE

U.S. Provisional Application No. 61/395,967 is hereby incorporated by reference in its entirety.

### BACKGROUND

The present invention relates to methods for seeking and obtaining from others personal appearance styling recommendations, and recommended purchasable style accessories, suitable for users attending selected events prior to their doing so, and following such events, for others evaluating the style selected, and the appearance made, by users at those events and, more particularly, practicing such methods over an interactive computer based network.

Selecting styles such as hairstyles, and the necessary accompanying accessories, by a person intending to attend a significant social or business event is not only determined by the personal characteristics and preferences of that person, but also by what that person thinks that friends or family members, or both, will also prefer for that person. Because of the rather large range of possible choices both known and unknown, and because of the more or less unknown preferences of others in this regard, such a person may find making such choices difficult to complete if unaided in doing so.

However, the obtaining of sufficient information as to the range of such choices suited to the person for attending such an event is both time consuming and subject to omissions in view of the many possibilities. Further, the soliciting of opinions of others in these matters, such as family members and friends, based on their having a real understanding of the possible alternatives to undergird their opinions is difficult to arrange without undue impositions on such others. Yet a person intending to be at such an event wants to make the best possible choices, or at least good or correct choices, as to the appearance they present at the event as there is often a competitive aspect in the appearances of the various attendees. Thus, there is desired a style selection aiding arrangement for persons intending to attend significant events which also allows comparisons and evaluations of the selections both before and after the event.

### SUMMARY

A method is provided of assisting a user with a selection of a personal appearance style over an interactive computer based network. Digital images of personal appearance styles are stored on a host computer in a database. Combinations of physical characteristics and personality characteristics are also stored on the host computer in the database, as are various business and/or social events. Information is received from the user related to physical and/or personality characteristics of the user, and related to an event the user will be attending. The host computer then determines personal appearance styles that are compatible with the user's physical and/or personality characteristics and the event the user will be attending, and transmits and displays those personal appearance styles to the user.

A method is further provided to receive and compile feedback through a social networking arrangement over an interactive computer based network on a personal appearance style selected by a user for a past event. The user uploads at least one photograph of the user displaying the personal appearance style at the past event. The user then invites opinions and/or commentary by friends and/or family members on the personal appearance style of the user displayed in the at least one photograph, with an electronic message to selected friends and/or family members over the interactive computer based network. The host computer receives the opinions and/or commentary of the selected friends and/or family members on the personal appearance style of the user displayed in the at least one photograph, and stores records in a database on the host computer reflecting the opinions and/or commentary received.

### BRIEF DESCRIPTION OF THE DRAWINGS

FIG. 1 shows a flow chart of a method for entering data characterizing various styling alternatives and corresponding pictorial displays thereof into computer based data storage,

FIG. 2 shows a flow chart of a method for associating various styling alternatives with groups of selected human physical features judged as together providing suitable appearances, and for associating various styling alternatives with selected social and business events, and entering the resulting arrays of associations into computer based data storage,

FIG. 3 shows a flow chart of a method for a site user to access, over a computer based network, a host computer based vendor web site with access to the computer based data storage to thereby be able to enter data as to the personal characteristics of that user along with an event selection and thereafter obtain corresponding styling and purchasable styling accessories suggestions over the computer based network for such an event,

FIG. 4 shows a flow chart of a method for a site user to invite, over a computer based network, recipient family members or friends, or both, to view a pictorial presentation on the host computer based vendor web site of a style choosable for a selected event, and to request the recipients to return to that user their opinions of that style in the circumstances so as to permit the recipients to choose to provide such a return over the computer based network,

FIG. 5 shows a flow chart of a method for the vendor to invite site users, over a computer based network, to enter an event user appearance contest after the occurrences of their corresponding events and for such site users, if entering, to invite recipient family members or friends, or both, to view pictorial presentations on the host computer based vendor web site of the user at the corresponding user event with the style chosen by the user for that event, and to request the recipients to return to the user over the computer based network their opinions as to the appearance of the user at the event and, comparatively, as to the appearances of any other similar site users at that event, or other events during a contest entry time period, so as to permit the recipients to choose to provide such a return over the computer based network, and

FIG. 6 shows a flow chart of a method for the vendor to invite site users, over a computer based network, to invite recipient family members or friends, or both, to view pictorial presentations on the host computer based vendor web site of the user at the corresponding user event with the style chosen by the user for that event, and to request the recipients to return to the user over the computer based network their opinions as to the appearance of the user at the event so as to permit the recipients to choose to provide such a return over the computer based network.

### DETAILED DESCRIPTION

The personal style interactive consulting, implementing and opinion gathering arrangement of the present invention for use with user selected events, and operated through a host computer based vendor web site over an interactive computer network based on the Internet, provides a method for inquiring internet site users to obtain event styling recommendations suitable to them. That is, this styling interactive network arrangement helps site users to choose one of a plurality of predetermined hairstyles specific for an event they may choose to attend, and to order corresponding style implementations kits to aid in achieving the desired style. The hairstyle that is, or the hairstyles that are, appropriate to selected events, out of a plurality of predetermined hairstyles, are further matched to an inquiring site user by suitable computer programs in the host computer based upon the physical characteristics, hair characteristics, age, and, if over 14 years of age, also based upon personality characteristics, that have all been previously submitted over the network to the host computer by that user.

To do so, various predetermined hairstyles being considered are stored as digital images by the operator, or through the operator, on the host computer in a database, and the various possible combinations of physical characteristics being considered, hair characteristics being considered, ages and personality characteristics being considered are similarly stored in the host computer database as basic combination sets. The operator, or someone acting through the operator, judges which of the predetermined hairstyles are suitable for each of the basic characteristic combination sets, and also judges which of the predetermined hairstyles are suitable for each of the possible events, and has the resulting relationships also stored in the host computer database.

Then, upon a site user inquiring as to suitable styles over the computer network at the vendor web site on the host computer, and following that user selecting an event type as well as having provided requested personal characteristics, the computer program in the host computer retrieves the corresponding basic combination set or sets to be used with the kind of event selected by the user. This set or these sets serve as the basis for those computer programs in the host computer to provide to the inquiring user a recommended hairstyle, or recommended alternative hairstyles, appropriate to both the selected event and personal characteristics of that site user.

Once the recommendation is made, the site user may then use the styling interactive network arrangement to choose to have the web site host computer e-mail the information for this recommended hairstyle over the computer network to family or friends, or both. The user can then obtain over the computer network from them, if they so choose, their responses to that hairstyle for the user for the event. Similarly, the user may use the arrangement to e-mail to them any further alternative hairstyles being considered by the user for the selected event that the user is planning to attend, and to again obtain from the recipients any further responses they choose to make.

After that event has occurred, site users are e-mailed by the web site host computer over the computer network an invitation inviting them to upload, into the web site host computer over the computer network, images of themselves taken in connection with the event wearing the hairstyle chosen therefor. Such site users may then use the styling interactive network arrangement to choose to have the web site host computer e-mail the information for this event hairstyle over the computer network to family or friends, or both, to obtain from them if they so choose, again over the computer network, their responses to the hairstyle used for the event.

Site users, after the event has occurred, are also e-mailed by the web site host computer over the computer network an invitation inviting them to participate in an appearance contest by entering during a contest entry period that includes the date of the event. To participate in the contest, site users upload, into the web site host computer over the computer network, images of themselves taken in connection with the event wearing the hairstyle chosen therefor. A site user then uses the styling interactive network arrangement to choose to have the web site host computer e-mail the information for this event hairstyle over the computer network to family or friends, or both, to obtain, over the computer network from them if they so choose, their responses to the hairstyle used for the event. Family and friends score the hairstyle. The scores from all site users are maintained and, following the close of the contest entry period, a winner is selected. The winner is one who has the highest number of score points. The winner is notified of their contest success via e-mail by the web site host computer over the computer network.

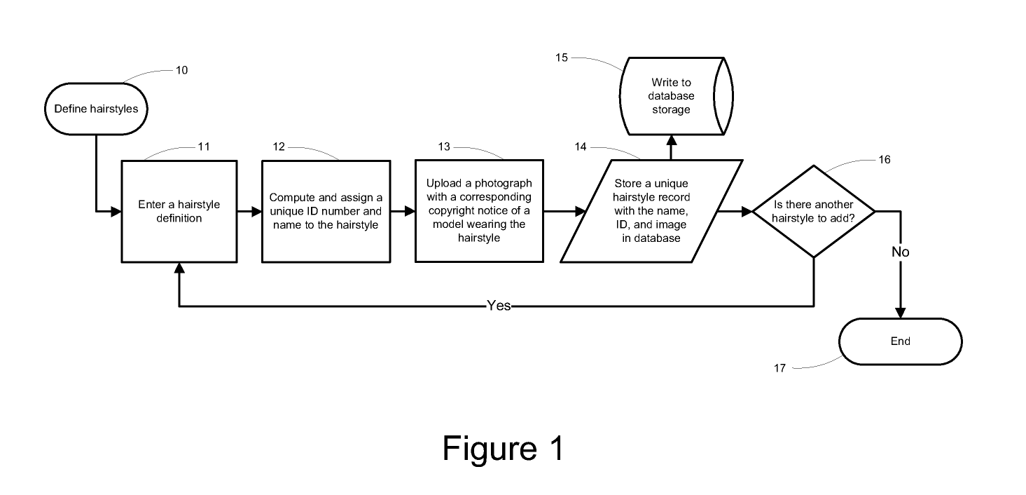

The foregoing is shown in more detail in the following styling interactive network arrangement operational and computer program flow charts. FIG. 1 shows a process in a flow chart for creating a hairstyle record and adding it to the database of the vendor web site host computer. The process is labeled “Define hairstyles” in a start balloon, 10.

A group of hairstyles is pre-selected with a suitable definition for each and definitions are entered into the web site host computer in a box, 11. The first of these hairstyle definitions is assigned a unique ID number and named to provide a basis for storing and retrieving it in the web site host computer database in a further box, 12. Next, a photograph of a human model wearing the hairstyle corresponding to the hairstyle definition is uploaded into the web site host computer in a subsequent box, 13. The accumulated information concerning the hairstyle definition is stored by the web site host computer in a parallelogram, 14, in the corresponding computer database, 15.

The web site host computer checks to determine if another hairstyle definition is available to have similar information accumulated thereabout in a decision diamond, 16. If so, the web site host computer directs the process to repeat in box 11 until the all of the entered hairstyle definitions have the needed information thereabout accumulated and entered into the web site host computer database. If no others have been entered by the vendor, the web site host computer directs the process to end in an ending balloon, 17.

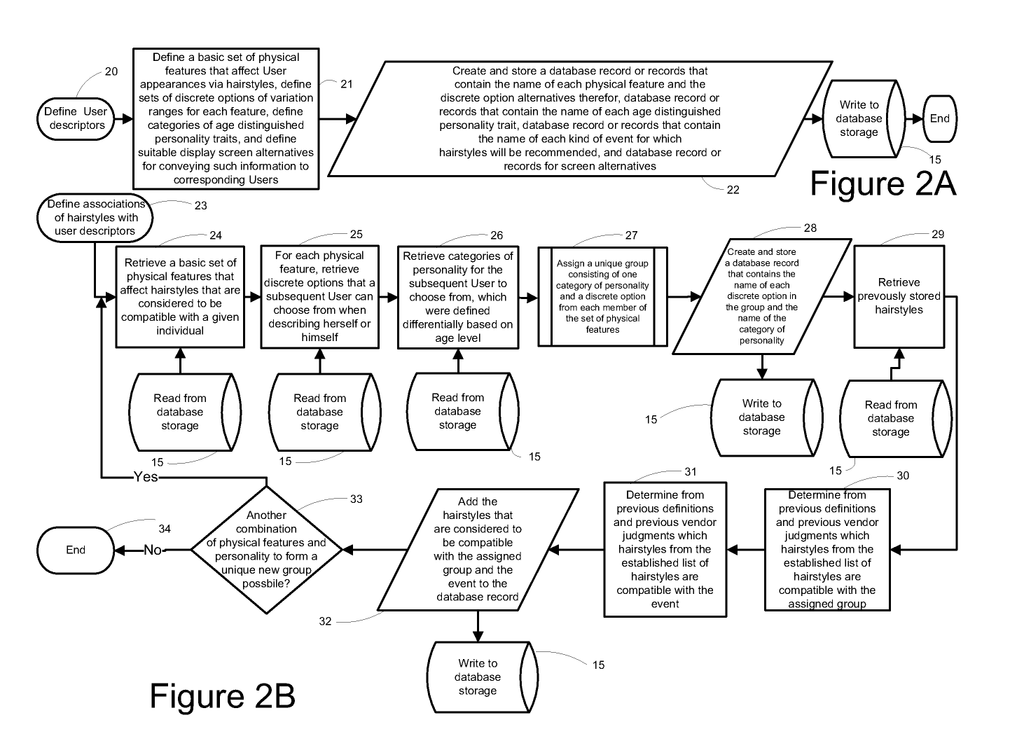

FIG. 2 shows a process in flow charts for creating a computer accessible “lookup table” to match specific user personal characteristics (based upon personal physical features and personality categories) and events with the hairstyles previously defined in FIG. 1, and then adding each resulting combination as a record in database 15 of the vendor web site host computer. In FIG. 2A, descriptors for the user personal characteristics are defined. The process is labeled “Define user descriptors” in a start balloon, 20. The vendor defines in the web site host computer at a box, 21, of FIG. 2A a basic set of human physical features thought important to establishing the appearances of humans to other humans in connection with hairstyles. Then a further set of selection options is defined there by the vendor covering the range of variation for each such feature, and from which a site user can select one to thereby establish an appearance characterization for that feature within the range of variation thereof. The vendor also defines there a basic set of categories of personality traits, or personality categories, which are distinguished at least in part by ages of users. Finally, the vendor defines the different social and business events for which hairstyles will be recommended at the web site. These definitions are used to create and store a database record or records that contain the name of a discrete option for a physical feature and a record or records that contain the name of each personality category in a parallelogram, 22, which are stored in database 15.

Thereafter, the host computer in FIG. 2B finds and stores each combination of these definitions. The process is labeled “Define associations of hairstyles with user descriptors” in a start balloon, 23. To do so, the host computer retrieves the basic set of physical features from database 15 in a box, 24, retrieves the corresponding sets of discrete options from database 15 in a box, 24, retrieves the basic set of personality categories from database 15 in a box, 25, and finally retrieves the previously defined hairstyles from database 15 in a box, 26. Each combination of these features are then assigned in a box, 27, either exhaustively by the host computer, or just those of these possible combinations selected by the host computer or by the vendor, or both, to a unique group. Each such group thus consists of one category of personality and several discrete options, one for each physical characteristic that is in the basic set of physical characteristics. Thereafter, the host computer in a parallelogram, 28, creates and stores in database 15 a database record for each group containing the name of each discrete option therein and the personality category therein.

Next, the host computer retrieves the hairstyles previously defined by the vendor from database 15 in a box, 29. The vendor in a box, 30, uses the host computer and the previous definition of each hairstyle to assign each hairstyle judged suitable for use with a group to that group in a group-hairstyle compatibility list. Again, the vendor in a box, 31, uses the host computer and the previous definition of each hairstyle to assign each hairstyle judged suitable for use at a social or business event to that event in a group-hairstyle-event compatibility list as an extension of the group-hairstyle compatibility list. The vendor then uses the host computer in a parallelogram, 32, to create and store in database 15 a record for each entry in the group-hairstyle-event compatibility list to form a portion of a “look up” table. Thereafter, the host computer determines in a decision diamond, 33, whether there are any more physical feature discrete option sets and personality category combinations possible to form a unique group. If so, the host computer returns to box 24 to begin the process again with the components for forming another group. If not, the process ends in an ending balloon, 34.

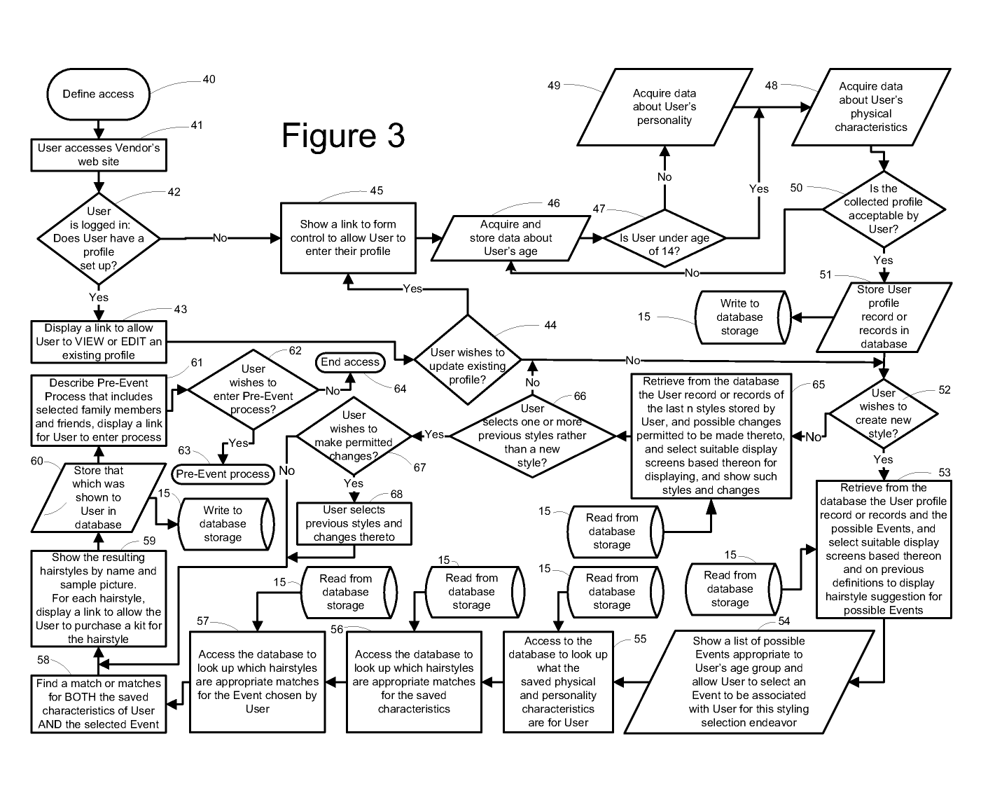

FIG. 3 shows a process in a flow chart for a site user to gain access over the interactive computer network to the vendor web site host computer and its database to provide personal characteristics data thereto, along with an event type selection, and to receive in return a styling recommendation. The process is labeled “Define access” in a start balloon, 40. The site user accesses the vendor web site host computer in a box, 41, to log in, and the host computer then determines in a decision diamond, 42, whether the logged-in site user has a stored personal characteristics profile.

If that user is determined in decision diamond 42 to have such a profile, the host computer directs the user in a box, 43, to view the profile they had previously entered. The host computer then has the user determine in a decision diamond, 44, determine whether that user wishes to update the user's personal characteristics profile. If so, the user is directed from decision diamond 44 to a box, 45, to begin changing as desired whatever information is stored as that user's personal characteristics profile. If not, the user is directed from decision diamond 44 to skip the personal characteristics profile data entry steps and begin getting a styling recommendation as will be further described below.

If the logged-in site user is determined in decision diamond 42 to not have such a stored personal characteristics profile, the host computer directs the user from there to box 45 to change from nothing having been previously stored about the user to begin enabling the user to create the user's own personal characteristics profile record or records to subsequently be stored in the host computer database for the user's current and possible future use. The host computer requests personal characteristics information from the user beginning with the user's age in a parallelogram, 46. Thereafter, the host computer determines whether the user is under the age of fourteen years or not in a decision diamond, 47. If so, the host computer requests personal characteristics information from the user as to the physical characteristics thereof in a parallelogram, 48, by displaying to that user the physical feature and the corresponding variation range discrete options available for that characteristic as defined by the vendor in the process of FIG. 2A, and from among which the user chooses one for each such physical characteristic. If not, host computer requests personal characteristics information from the user as to the personality thereof in a parallelogram, 49, through displaying to that user the personality categories defined by the vendor in FIG. 2A, and thereafter also requests information as to the physical characteristics of that user in parallelogram 48 as described above.

After gathering the responses of the user to these questions as posed by the host computer, that computer then determines in a further decision diamond, 50, whether the gathered responses are acceptable to the user for establishing the user's personal characteristics profile. If acceptable, the accumulated information concerning the personal characteristics of the user is stored by the host computer in a parallelogram, 51, in the corresponding computer database 15. If not acceptable, the user is directed by the host computer back to box 46 to begin repeating the personal characteristics questions and responses process until an acceptable user profile is prepared and stored in database 15.

Either after the web site host computer has determined that (a) the current site user does not wish to change the corresponding personal characteristics profile stored in database 15 for that user in decision diamond 44, or has alternatively determined (b) that any new or changed corresponding personal characteristics profile initiated by that user has also been accepted by that user in decision diamond 50 and stored in database 15 at parallelogram 51, the host computer inquires of the site user whether that user wishes to create a new style including a new hairstyle for the anticipated coming event or not in a further decision diamond, 52. If so, the host computer prepares to transmit a return message with recommendations to the current site user in a box, 53. If not, the alternative for the site user is the reuse of a previous selected style choice but subject to allowed alterations selectable by the site user as will be described below.

Considering first the site user selecting to create a new style in decision diamond 52, the web site host computer in box 53 retrieves the personal characteristics profile corresponding to the current site user from database 15 (unless still in the computer memory after the storage thereof in parallelogram 51) and a list of selected Events deemed possible to be attended by the user in view of the user's profile. The program in the host computer then determines the selection of the display screen alternative, or alternatives, based on that user's corresponding personal characteristics profile and previous judgments of the vendor, to be used to transmit to that user corresponding style recommendations for the selected possible Events.

The host computer then retrieves from database 15, in a parallelogram, 54, the list of selected possible Events that seemingly might be attended based on the user's personal characteristics profile, and displays a list of those Events to the current site user to allow that user to select the desired Event from that list in parallelogram 54. After the current site user has selected an Event to be associated with that user for this styling selection endeavor, the host computer retrieves from the database first, in a box, 55, the physical and personality characteristics of that user, second, in a box, 56, the hairstyles previously defined and judged as appropriate for those characteristics, and finally, in a box, 57, the hairstyles previously defined as appropriate for the selected Event.

Thereafter, the host computer determines those of the hairstyles that are compatible with both the user's characteristics and the user's selected Event in a box, 58, and transmits the information over the computer network to display the resulting hairstyles as suggestions to that user in a further box, 59. In addition in that box, the host computer transmits the information needed to allow the user to review hairstyle aid kits that correspond to the hairstyle suggestions sent, and allows a link to be established which the user can use to purchase one or more such kits. The style information and suggestions shown to the user in box 59, and any kit orders, are also stored in database 15 in a following parallelogram, 60.

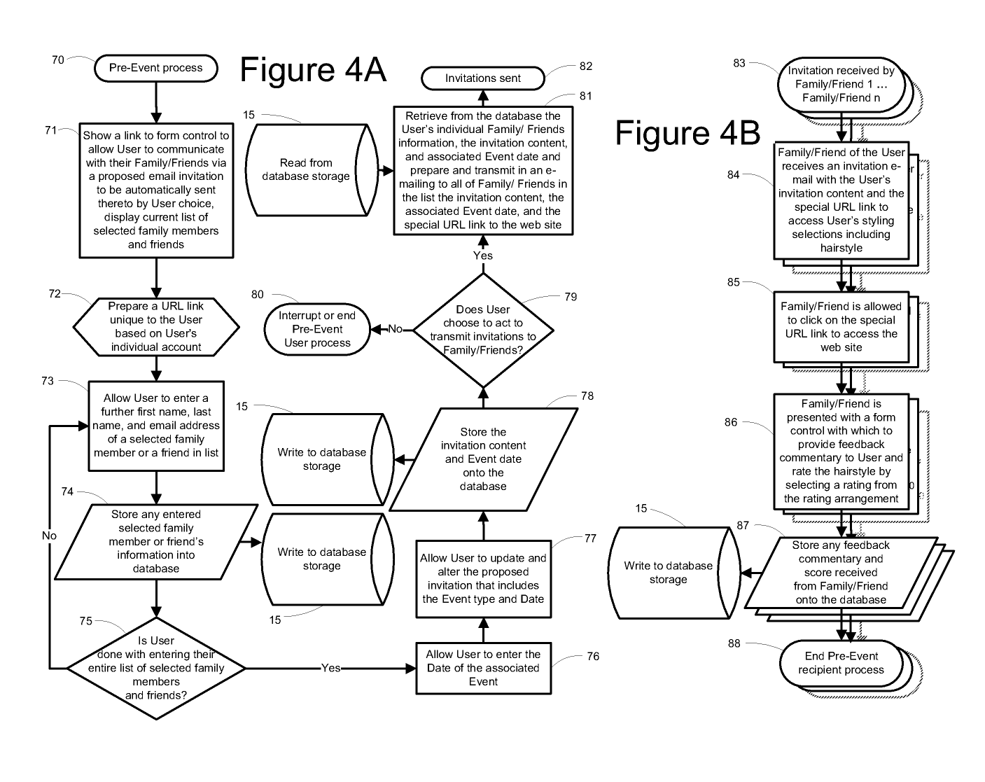

The user, having seen the hairstyle suggestions at the user's computer, is then informed by the host computer of the opportunity to show over the computer network this styling information to selected family members and friends in a subsequent box, 61, and to invite their collaboration in the user's choices for the Event. This opportunity can be accepted by the user in a decision diamond, 62, and which is then undertaken in an arrangement designated as the Pre-Event process in a balloon, 63. That is, a link is provided in box 61 to enter that Pre-Event process through a selection made in decision diamond 62 thereby directing the site user thereto through balloon 63, a process which is thereafter described in FIG. 4. If, on the other hand, the site user does not wish to collaborate with others through entering the Pre-Event process, or does not wish to at that time, the alternative is to end the interactive session with the host computer through making that selection in decision diamond 62 which directs the user into ending such access to the host in another balloon, 64.

Now considering the alternative available in decision diamond 52 of reusing a previously chosen style, typically one having been earlier chosen for another Event, a decision there not to create a new style leads to the web site host computer in a box, 65, to retrieve from database 15 the record or records of the site user describing a selected number of the last styles, including hairstyles, created by that user, and a list of the possible changes that are permitted to be made to them to better suit them to the user's preferences for the anticipated next coming Event intended to be attended by that user. The program in the host computer then determines a corresponding suitable display screen, or suitable display screens, based on these last style choices of that user and on the previous judgments of the vendor as to permitted changes for each, to be used to transmit to that user the selected previously used styles and corresponding style alteration recommendations for possible Events of the same kind. These reach the site user and are shown thereto on that user's computer monitor screen.

The site user, having seen the styles previously chosen by that user, can then decide in a decision diamond, 66, whether one or more of them is appropriate to be selected for the upcoming Event that this user intends to attend, or instead to return to decision diamond 52 to choose to create a new style rather than selecting a previously used style. If the user decides to select one or more previously used styles in decision diamond 66, the user then, in another decision diamond, 67, selects whether, and which, of any permitted changes to those styles are desired to be incorporated therein by the user.

If the user has selected one or more previous styles, but wishes to make permitted changes thereto, the user selects those of the previous styles that are to be changed, and the corresponding changes, in a box, 68, and the host computer, then receiving these selections, transmits the corresponding information over the computer network to display the resulting hairstyles to that user in box 59 as before. If the user selects one or more previous changes in decision diamond 66, and chooses not to make any of the permitted changes thereto in decision diamond 67, the host computer through box 59 transmits the corresponding information over the computer network to display the resulting hairstyles to that user. In either instance of previously selected styles, whether changed or not, once the style information has been shown by the host computer over the computer network to the user in box 59, what was shown is stored in database 15 via parallelogram 60 and the user again has the choice to enter the Pre-Event process or end the access to the host computer as described above.

FIGS. 4A and 4B depict these Pre-Event interactive processes in flow charts showing that the style possibilities for the selected Event can be transmitted by the site user in an invitation to selected family or friends. These selectees are invited to interactively collaborate with the site user in making style choices for that user to adopt in attending the selected Event, and this invitation, and any such resulting collaboration, together thus form a “social networking” arrangement over the computer network operated through the host computer at the vendor website. Here, website users are able to invite, over the computer network through the host computer, selected ones of their friends or family members, or both, to collaborate on the users' styling selections such as a hairstyle choice and enhancements therefor, or on the evaluation of possible alternative choices, after viewing such a styling choice or various choice alternatives sent by the user. This collaboration is accomplished through the invitation recipients providing over the computer network to that user their views on the styling choice, or possible choices, such as hairstyle choice any corresponding style enhancers chosen by the user to supplement any style choices made.

The invitation formation and transmission process begins at a Pre-Event balloon, 70, which can be reached at Pre-Event process balloon 63 in FIG. 3, as indicated above, or can be entered directly over the computer network without having been immediately previously in the style selection process of FIG. 3. Thus, the user can start the Pre-Event process immediately after, or at a later time after, having completed the style selection process in FIG. 3, and can also return to the Pre-Event Process directly after having chosen to leave that process temporarily.

In entering the Pre-Event process, the site user is first shown in a box, 71, a link over the computer network to a form control to allow that user to communicate with their family or friends, or both, by sending them a proposed e-mail invitation, and displaying a current listing of such members and friends kept in database 15 by the host computer of those family members and friends that may have been previously selected, if any. This e-mail invitation will be automatically sent to selected friends and family over that link upon the user subsequently choosing to do so, and will invite opinion or commentary, or both, based on the style selections of that user determined in the interactive style selection process of FIG. 3. In preparation for such sending to the selected recipients, a URL link that is unique to the user, and which is based upon the user's individual account, is prepared in a stretched hexagon, 72, by the host computer at the vendor website. The user is then allowed in a box, 73, to add to the list first displayed at box 71 a further selected family member or friend by name and e-mail address.

Any additional entry is stored in database 15 in a box, 74, and the user is then queried in a decision diamond, 75, even if there was no addition to the list, whether the user has finished entering selected family members or friends in the list. If not, the user reenters box 73 to provide another entry. If the user makes no additional entry to the list in first entering box 73 and indicates in decision diamond 75 to be finished, the user effectively skips through any further list development to proceed on to a box, 76, where that user is requested to enter the calendar date of the previously selected Event. If the user has made an additional entry upon entering box 73 and indicates in decision diamond 75 to not be finished, the user then effectively either develops a new list, or further develops a previously prepared list, by repeating this entry process as often as desired until indicating in decision diamond 75 to be finished. Thereafter, the user then proceeds on to box 76 where that user, as indicated above, is requested to enter the calendar date of the previously selected Event. Thus, upon completing the list of selected family members and friends, the user needs only to complete the form of the invitation to be sent to them, and to decide whether to send their invitations to them.

Hence, the user is next allowed in a following box, 77, to update and alter their proposed invitation to their selected family and friends including the Event type and the date of that Event and to change or comment upon selected aspects of the styles information resulting from the interactive style selection process of FIG. 3. The invitation content, including the Event date and Event type, is then stored in database 15 in a parallelogram, 78.

The site user at this point in the Pre-Event process can decide in a further decision diamond, 79, whether to then transmit their invitations to those on the previously completed list or leave the Pre-Event process at decision diamond 79 through an end balloon, 80. The site user, if having chosen to leave and then return later, can reenter the process at Pre-Event process balloon 70 to a) put additional or altered entries in the list or invitation information and store them in database 15 by again reaching parallelogram 74 and decision diamond 75, or to b) again reach decision diamond 79 after reaching decision diamond 75 through skipping the providing of additional or altered entries.

Once a decision is made in decision diamond 79 to transmit from the host computer over the computer network the stored invitations to the selected family members and friends in the list, the invitation form is prepared in a box, 81, and transmitted to all of the user's selected friends and family in the user's list along with the special URL link to the vendor web site. This invitation includes information about the Event type and date of the associated Event, and also the special URL link allowing the recipients to see at the vendor website the styles being considered by the user for the associated Event that were identified by the user in the interactive style selection process of FIG. 3. The invitations having been transmitted ends the site user portion of the Pre-Event process in an invitations sent balloon, 82.

The recipient part of the Pre-Event process, in which those receiving invitations can see both the invitation sent to them and the selection information of the site user that is accessible over the URL link, begins in a recipients start balloon, 83, in the flow chart of FIG. 4B. Those selected family members and friends on the list, as indicated in a box, 84, receive a corresponding one of the invitations from the user asking them to respond with their opinions to that user based on the style selections of that user determined in the interactive style selection process of FIG. 3, and also receive the special URL link. Each such family or friend is then allowed in a subsequent box, 85, to click on the special URL link to gain access over the computer network the vendor web site to thereby see those styles. Each invitation recipient, in doing so, is presented over the computer network with a form control in a box, 86, in which that person is allowed to provide commentary to the site user as to their views of the choice made by, or choices made by, or choice alternatives available to, the site user for the Event, and to also rate the hairstyle or other styles chosen, or available to be chosen, with a suitable rating selected from a rating arrangement chosen by the vendor for this purpose. The commentary and rating values received at the web site host computer over the computer network from those of the selected friends and family members so responding are stored by the host computer in database 15 in a parallelogram, 87, to end the recipient part of the Pre-Event process in an end process balloon, 88.

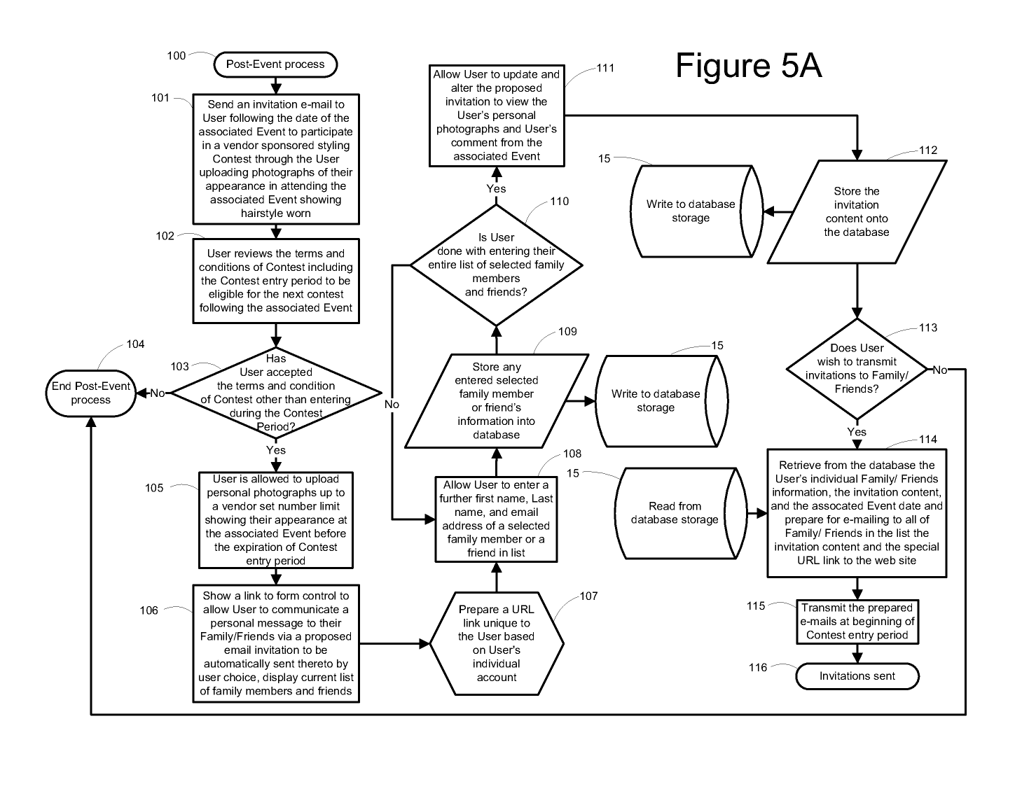

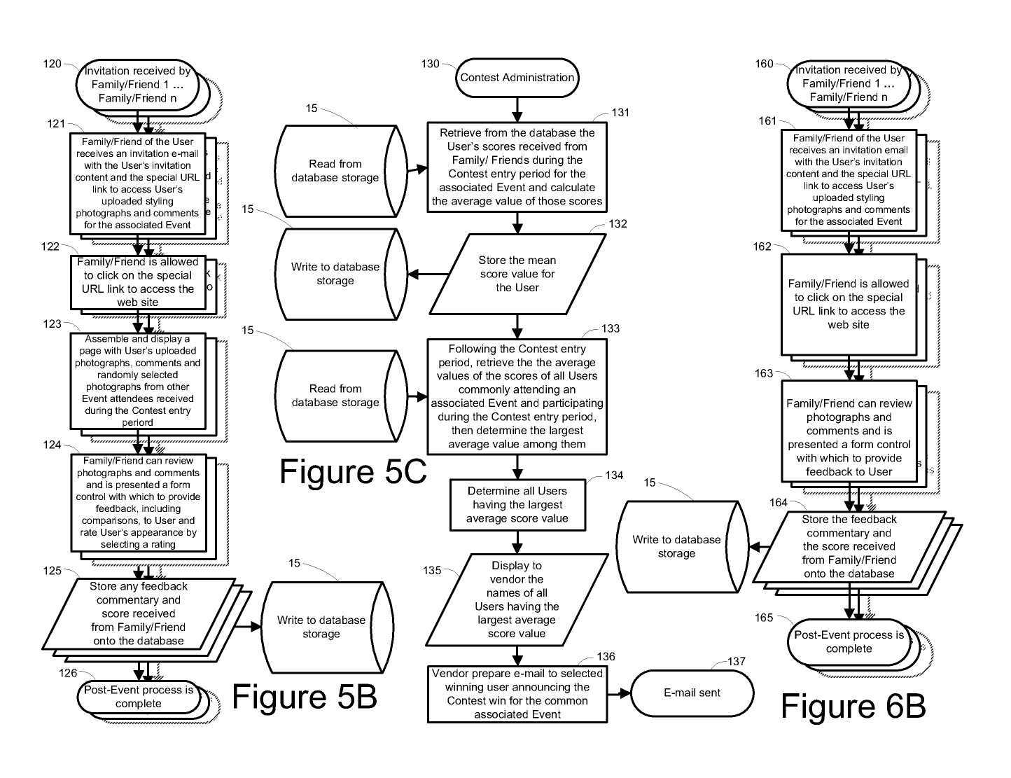

FIGS. 5A, 5B and 5C show processes in flow charts used for a vendor sponsored Post-Event contest initiated and managed by the vendor at the host computer vendor website, and carried out through a social networking arrangement over the computer network. The contest requires, in this arrangement, site users, having attended an Event, to obtain the affirmative support of selected family members and friends over the computer network after these selectees have viewed site user uploaded photographs taken of the corresponding user in connection with the Event attended by that user showing the styles chosen by this user for that Event.

FIG. 5A shows in a flow chart the activities of a site user undertaken to enter the vendor sponsored Contest, after the vendor has informed the site user of the contest opportunity beginning in a start balloon, 100, labeled Post-Event process. Invitations are e-mailed by the vendor from the host computer vendor website over the computer network in a box, 101, to selected site users following the dates on which associated Events occurred that were indicated previously to the vendor by these users as Events they intended to attend. Typically, such indications to the vendor by site users occur through those users having gained access to the vendor website in the process shown in FIG. 3 in their getting styling help from the vendor for a corresponding Event now being associated that user. Each such invitation invites the receiving site user to participate in the vendor's Style Contest, a contest usually primarily based on the hairstyle selected by the site user for the associated Event as supplemented by any vendor products used therewith.

Before beginning any contest entry activity, the user must indicate to the vendor over the computer network at the host computer website acceptance of the vendor's terms and conditions for doing so. Thus, an invited site user in a box, 102, is shown these Contest terms and conditions which include the contest entry period to be eligible for the next Contest following the Event associated with that user. The invited site user can accept or reject such terms and conditions in a decision diamond, 103, with rejection leading immediately to the vendor host computer directing the rejecting site user out of the Post-Event process in an End Post-Event process balloon, 104.

If, instead, the invited site user indicates acceptance of the vendor sponsored Contest terms and conditions in decision diamond 103, that user is then directed by the vendor host computer to undertake entering the contest through accepting the opportunity in being allowed in a box, 105, to upload to the vendor host computer up to a vendor selected limit number of personal photographs taken of themselves in connection with the Event associated with them. Such photographs could be directly downloaded by the invited site user from a digital camera memory into the memory of the computer of that user, or could be entered in that memory through having the finished photograph scanned by the user in a digital scanner to provide the corresponding data to be directed into that memory.

Following such uploading, the site user is then shown in a box, 106, a link over the computer network to a form control to allow that user to communicate with their family members or friends, or both, by sending them a proposed e-mail invitation, and displaying a current listing of such members and friends kept in database 15 by the host computer of those family members and friends that may have been previously selected, if any. This e-mail invitation will be automatically sent to selected friends and family over that link upon the user subsequently choosing to do so, and will invite opinion or commentary, or both, based on the styles used by that user in attending the associated Event. In addition, such recipients may also be asked to comment on comparisons to the styles chosen by others that attended the same Event. In preparation for such sending to the selected recipients, a URL link that is unique to the user, and which is based upon the user's individual account, is prepared in a stretched hexagon, 107, by the host computer at the vendor website. The user is then allowed in a box, 148, to add to the list first displayed at box 106 a further selected family member or friend by name and e-mail address.

Any additional entry is stored in database 15 in a box, 109, and the user is then queried in a decision diamond, 110, even if there was no addition to the list, whether the user has finished entering selected family members or friends in the list. If not, the user reenters box 108 to provide another entry. If the user makes no additional entry to the list in first entering box 108 and indicates in decision diamond 110 to be finished, the user effectively skips through any further list development to proceed on to a box, 111, where that user is requested to review the invitation form. If the user has made an additional entry upon entering box 108 and indicates in decision diamond 110 to not be finished, the user then effectively either develops a new list, or further develops a previously prepared list, by repeating this entry process as often as desired until indicating in decision diamond 110 to be finished. Thereafter, the user then proceeds on to box 111 where that user, as indicated above, is requested to review the invitation. Thus, upon completing the list of selected family members and friends, the user needs only to complete the form of the invitation to be sent to them, and to decide whether to send their invitations to them.

Hence, the user is next allowed in following box 111 to update and alter their proposed invitation to their selected family and friends including selectively commenting upon aspects of the associated Event experienced by the site user, the satisfaction with the selected styles, and the uploaded photographs. The invitation content is then stored in database 15 in a parallelogram, 112.

The site user at this point in the Post-Event process can decide in a further decision diamond, 113, whether to then transmit their invitations to those on the previously completed list or leave the Post-Event process at decision diamond 113 through end balloon 104. The site user, if having chosen to leave and then return later, can reenter the process at Post-Event process balloon 100 to a) put additional or altered entries in the list or invitation information and store them in database 15 by again reaching parallelogram 112 and decision diamond 113, or to b) again reach decision diamond 113 after reaching decision diamond 110 through skipping the providing of additional or altered entries.

Once a decision is made in decision diamond 113 to transmit from the host computer over the computer network the stored invitations to the selected family members and friends in the list, the invitation form is prepared in a box, 114, as is the special URL link to the website for inclusion in an e-mail. An e-mailing then subsequently occurs at the beginning of the corresponding Contest entry period in a box, 115, with e-mails being transmitted to all of the user's selected friends and family in the user's list along with the special URL link to the vendor web site. This invitation includes information about the Event type and date of the associated Event, and also the special URL link allowing the recipients to see at the vendor website the information uploaded by the site user. The invitations having been transmitted ends the site user portion of the Post-Event process in an invitations sent balloon, 116.

In the recipient's portion of the Post-Event process, those receiving the invitations can see both the invitation sent to them and also the uploaded photographs and comments of the site user over the URL link, this portion beginning in a recipient start balloon, 120, in the flow chart of FIG. 5B. Those selected family members and friends on the list, as indicated in a box, 121, receive a corresponding one of the invitations from the user asking them to respond to that user with their opinions based on the stylings such as the hairstyle used by that user during the user's attendance at the associated Event, and also receive the special URL link. Each such family member or friend is then allowed in a subsequent box, 122, to click on the special URL link to gain access over the computer network to the vendor web site thereby causing the host computer in a further box, 123, to assemble and display a page with the uploaded photographs, comments and randomly selected other photographs of other attendees at the associated Event that were received during the Contest Entry period. Thus, the family member or friend clicking on the special URL link thereby sees the stylings including hairstyle used by the site user at the associated Event in that user's uploaded photographs along with related information viewed in any commentary added thereto by that user, and some of the stylings chosen by other attendees at that Event.

Each invitation recipient, in connection with their reviewing, is presented over the computer network with a form control in a box, 124, in which that person is allowed to provide commentary to the site user as to their views of the appearance of the site user at the associated Event, including in comparison with the appearances of selected other Event attendees, and to also rate the hairstyle or other styles chosen by the site user by selecting an appearance approval rating from those set out in the form corresponding to the rating arrangement chosen by the vendor for this purpose. This may well be a competitive appearance approval rating if the photographs of others attending the Event have also been displayed and the relative appearances of all photographs presented are being rated. A simple example would be selecting a rating score on a scale of from 1 through 100. The commentary and ratings received at the web site host computer over the computer network from those of the selected friends and family members so responding are stored by the host computer in database 15 in a parallelogram, 125, to end the recipient part of this Post-Event process in an end process balloon, 126.

The administration process of the vendor sponsored Contest in the host computer at the vendor website is shown beginning in a start balloon, 130, in the flow chart of FIG. 5C. The host computer, in a box, 131, retrieves from database 15 each site user's ratings, from those recipients of each of those site user's invitations that have responded with such a rating, as to the appearance of the inviting site user for those site users attending a common associated Event. Upon retrieving this rating data, the host computer determines, for example, a corresponding appropriate group measure, such as an arithmetic average for the above 100 division scale example, of those received ratings for each such site user, in accord with the rating arrangement selected by the vendor for this purpose. These site users group measures, such as averages in the example, are stored by the host computer in database 15 in a parallelogram, 132.

After the Contest entry period has closed, the host computer at the vendor website in a box, 133, retrieves the site users group measures for those site users attending the common associated Event for which a contest winner is to be found, and sorts these measures, again, for example, arithmetic averages, to find the largest group measure value, i.e. the largest arithmetic average for the example given. The host computer in a box, 134, then identifies all of the site users in this largest group measure value sort, those that have an average value equal to that largest average value in the given example to result providing a list of one or more contest site users that is displayed for vendor review as indicated in a box, 135. The vendor prepares an e-mail in a box, 136, that is transmitted to the winner announcing the contest win in an end balloon, 137, thus completing the Contest.

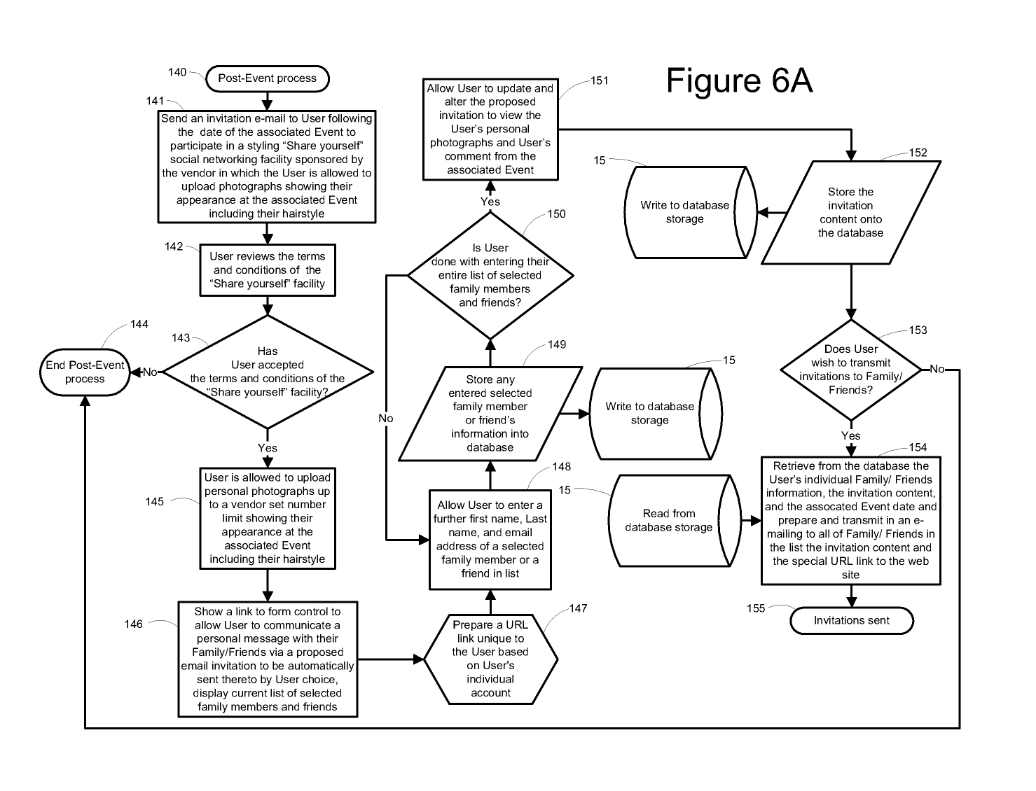

Apart from entering the vendor sponsored Contest announced to site users following the date of an associated Event, FIGS. 6A and 6B show processes in flow charts used for a vendor sponsored Post-Event social networking facility managed by the vendor at the host computer vendor website in which the site user and selected family members and friends can share in, and comment on, the site user's experience at the associated Event in a social networking arrangement provided over the computer network. The site user, in this arrangement, having attended the associated Event, initiates such an exchange with selected family members and friends over the computer network by inviting these selectees to view photographs uploaded by the site user that were taken of the corresponding user in connection with the Event attended by that user showing the styles chosen by this user for that Event.

FIG. 6A shows in a flow chart the activities of a site user undertaken to begin using the facility after the vendor has informed the site user of the sharing opportunity beginning in a start balloon, 140, also labeled Post-Event process. Invitations are e-mailed by the vendor from the host computer vendor website over the computer network in a box, 141, to selected site users following the dates on which associated Events occurred that were indicated previously to the vendor by these users as Events they intended to attend. Typically, such indications to the vendor by site users occur through those users having gained access to the vendor website in the process shown in FIG. 3 in their getting styling help from the vendor for the corresponding Event now being associated that user. Each such invitation invites the receiving site user to participate in the vendor's “Share Yourself” social networking facility to have selected family members and friends to view and exchange comments on the associated Event and the stylings, such as the hairstyle, selected by the site user to set that user's appearance for the associated Event as supplemented by any vendor products used therewith.

Before beginning any social networking activity, the user must indicate to the vendor over the computer network at the host computer website acceptance of the vendor's terms and conditions for doing so. Thus, an invited site user in a box, 142, is shown these “Share Yourself” social networking facility terms and conditions. The invited site user can accept or reject such terms and conditions in a decision diamond, 143, with rejection leading immediately to the vendor host computer directing the rejecting site user out of the Post-Event process in an End Post-Event process balloon, 144.

If, instead, the invited site user indicates acceptance of the vendor sponsored “Share Yourself” social networking facility terms and conditions in decision diamond 143, that user is then directed by the vendor host computer to undertake beginning such social networking through accepting the opportunity in being allowed in a box, 145, to upload to the vendor host computer up to a vendor selected limit number of personal photographs taken of themselves in connection with the Event associated with them. Such photographs could again be directly downloaded by the invited site user from a digital camera memory into the memory of the computer of that user, or could be entered in that memory through having the finished photograph scanned by the user in a digital scanner to provide the corresponding data to be directed into that memory.

Following such uploading, the site user is then shown in a box, 146, a link over the computer network to a form control to allow that user to communicate with their family members or friends, or both, by sending them a proposed e-mail invitation, and displaying a current listing of such members and friends kept in database 15 by the host computer of those family members and friends that may have been previously selected, if any. This e-mail invitation will be automatically sent to selected friends and family over that link upon the user subsequently choosing to do so, and will invite opinion or commentary, or both, based on the styles used by that user in attending the associated Event. In addition, such recipients will also be asked to provide a scored rating of those styles, and perhaps on a basis of comparisons to the styles chosen by others in attending the same Event, as data for the Contest. In preparation for such sending to the selected recipients, a URL link that is unique to the user, and which is based upon the user's individual account, is prepared in a stretched hexagon, 147, by the host computer at the vendor website. The user is then allowed in a box, 148, to add to the list first displayed at box 146 a further selected family member or friend by name and e-mail address.

Any additional entry is stored in database 15 in a box, 149, and the user is then queried in a decision diamond, 150, even if there was no addition to the list, whether the user has finished entering selected family members or friends in the list. If not, the user reenters box 148 to provide another entry. If the user makes no additional entry to the list in first entering box 148 and indicates in decision diamond 150 to be finished, the user effectively skips through any further list development to proceed on to a box, 151, where that user is requested to review the invitation form. If the user has made an additional entry upon entering box 148 and indicates in decision diamond 150 to not be finished, the user then effectively either develops a new list, or further develops a previously prepared list, by repeating this entry process as often as desired until indicating in decision diamond 150 to be finished. Thereafter, the user then proceeds on to box 151 where that user, as indicated above, is requested to review the invitation. Thus, upon completing the list of selected family members and friends, the user needs only to complete the form of the invitation to be sent to them, and to decide whether to send their invitations to them.

Hence, the user is next allowed in following box 151 to update and alter their proposed invitation to their selected family and friends including selectively commenting upon aspects of the associated Event experienced by the site user, the satisfaction with the selected styles, and the uploaded photographs. The invitation content is then stored in database 15 in a parallelogram, 152.

The site user at this point in the Post-Event process can decide in a further decision diamond, 153, whether to then transmit their invitations to those on the previously completed list or leave the Post-Event process at decision diamond 153 through end balloon 144. The site user, if having chosen to leave and then return later, can reenter the process at Post-Event process balloon 140 to a) put additional or altered entries in the list or invitation information and store them in database 15 by again reaching parallelogram 152 and decision diamond 153, or to b) again reach decision diamond 153 after reaching decision diamond 150 through skipping the providing of additional or altered entries.

Once a decision is made in decision diamond 153 to transmit from the host computer over the computer network the stored invitations to the selected family members and friends in the list, the invitation form is prepared in a box, 154, and transmitted to all of the user's selected friends and family in the user's list along with the special URL link to the vendor web site. This invitation includes information about the Event type and date of the associated Event, and also the special URL link allowing the recipients to see at the vendor website the information uploaded by the site user. The invitations having been transmitted ends the site user portion of the Post-Event process in an invitations sent balloon, 155.

In the recipient's portion of the Post-Event process, those receiving the invitations can see both the invitation sent to them and also the uploaded photographs and comments of the site user over the URL link, this portion beginning in a recipient start balloon, 160, in the flow chart of FIG. 6B. Those selected family members and friends on the list, as indicated in a box, 161, receive a corresponding one of the invitations from the user asking them to respond to that user with their opinions based on the stylings such as the hairstyle used by that user during the user's attendance at the associated Event, and also receive the special URL link. Each such family or friend is then allowed in a subsequent box, 162, to click on the special URL link to gain access over the computer network the vendor web site to thereby see those styles in the uploaded photographs along with related information viewed in any commentary added thereto by that user. Each invitation recipient, in connection with such reviewing, is presented over the computer network with a form control in a box, 163, in which that person is allowed to provide commentary to the site user as to their views of the appearance of the site user at the associated Event and other commentary. The commentary received at the web site host computer over the computer network from those of the selected friends and family members so responding are stored by the host computer in database 15 in a parallelogram, 164, to end the recipient part of this other Post-Event process in an end process balloon, 165.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of assisting a user with a selection of a personal appearance style over an interactive computer based network, comprising:
storing digital images of personal appearance styles on a host computer in a database;
storing combinations of physical characteristics and personality characteristics, on the host computer in the database;
storing various business and/or social events on the host computer in the database;
receiving from the user information related to physical and/or personality characteristics of the user;
receiving from the user information related to an event the user will be attending; and
determining, by the host computer, personal appearance styles that are compatible with the user's physical and/or personality characteristics and the event the user will be attending, and transmitting and displaying those personal appearance styles to the user.

2. The method of claim 1, further comprising:
inviting, by the user, collaboration by friends and/or family members in selection of a personal appearance style from the personal appearance styles determined to be compatible with the user's physical and/or personality characteristics and the event the user will be attending, by offering an opportunity to comment and/or rate the personal appearance styles with an electronic message to selected friends and/or family members over the computer network.

3. The method of claim 1, further comprising:
determining, by the host computer, personal appearance kits that correspond to the personal appearance styles that are determined to be compatible with the user's physical and/or personality characteristics and the event the user will be attending, and transmitting and displaying information to the user allowing a link to be established for the user to purchase one or more of the personal appearance kits.

4. The method of claim 1, wherein storing the digital images of personal appearance styles on the host computer in the database comprises:
selecting a group of personal appearance styles each having a definition;
entering the definitions for the personal appearance styles into the host computer;
assigning a unique identifier to each of the personal appearance styles;
uploading the digital images, representing photographs of human models in the personal appearance styles, to the host computer; and
storing all of the definitions and other information relating the personal appearance styles in the host computer in the database.

5. The method of claim 4, further comprising creating a computer accessible lookup table in the database in the host computer to match user physical and/or personality characteristics with the personal appearance styles, comprising:
defining descriptors and a range of variation for each of the user physical characteristics, from which the user may select to provide an appearance characterization related to each of the user physical characteristics;
defining a set of personality categories, from which the user may select to provide information related to personality characteristics of the user;
defining social and/or business events for which personal appearance styles will be recommended;
creating and storing physical characteristic records in the database that contain the name of a discrete option for a physical characteristic;
creating and storing personality category records in the database that contain the name of each personality category;
creating and storing group records in the database that each contain the name of a personality category and several discrete options of physical characteristics;
assigning personal appearance styles to the group records that are determined to be suitable for each defined group in a group-style compatibility list; and
creating and storing a record for each entry in the group-style compatibility list.

6. The method of claim 5, further comprising:
assigning personal appearance styles to the group records that are determined to be suitable for each defined group for use at determined social and/or business events in a group-style-event compatibility list; and
creating and storing a record for each entry in the group-style-event compatibility list.

7. The method of claim 1, wherein receiving from the user information related to physical and/or personality characteristics of the user comprises:
requesting, by the host computer, physical characteristics information comprising:
displaying at least one physical feature and the corresponding variation range discrete options available for that feature to the user; and
receiving the user's selection of one of the discrete options for the at least one physical feature; and
requesting, by the host computer, at least one personality category selection by the user.

8. The method of claim 7, wherein receiving from the user information related to the event the user will be attending comprises:
retrieving a list of selected events deemed possible to be attended by the user based on the physical characteristics information and/or the personality information; and
displaying the list of selected possible events to the user to allow the user to select an event that will be attended from the list.

9. A method of receiving and compiling feedback through a social networking arrangement over an interactive computer based network on a personal appearance style selected by a user for a past event, the method comprising:
uploading to the host computer, by the user, at least one photograph of the user displaying the personal appearance style at the past event;
inviting, by the user, opinions and/or commentary by friends and/or family members on the personal appearance style of the user displayed in the at least one photograph, with an electronic message to selected friends and/or family members over the interactive computer based network; and
receiving, at the host computer via the interactive computer based network, the opinions and/or commentary of the selected friends and/or family members on the personal appearance style of the user displayed in the at least one photograph, and storing records in a database on the host computer reflecting the opinions and/or commentary received.

10. The method of claim 9, wherein the electronic messages to selected friends and/or family members includes a unique link to a web site for displaying the at least one photograph uploaded by the user.

11. The method of claim 9, wherein the opinions and/or commentary of the elected friends and/or family members includes an appearance approval rating.

12. The method of claim 9, wherein inviting, by the user, opinions and/or commentary by friends and/or family members on the personal appearance style of the user displayed in the at least one photograph, further comprises:
inviting the selected friends and/or family members to participate in a personal appearance contest by reviewing the at least one photograph and providing the appearance approval rating.

13. The method of claim 12, further comprising:
comparing, at the host computer, appearance approval ratings for the user to appearance approval ratings received for other users; and
selecting a winner of the personal appearance contest based on the comparison of the appearance approval ratings received.
